(19) United States
(12) Patent Application Publication
(10) Pub. No.: US 2001/0043995 A1
(43) Pub. Date: Nov. 22, 2001

(54) Method of coating a substrate with a structural polymer

(76) Inventors: Joseph Charles Sgro, Lakewood, OH (US); Frank David Zychowski, Berea, OH (US)

Correspondence Address: Arnold S. Weintraub, Esq., Plunkett & Cooney, P.C., 38505 Woodward Avenue, Suite 3000, Bloomfield Hills, MI, 48034, US

(21) Appl. No.: 09/855,881

(22) Filed: May 15, 2001

Related U.S. Application Data
(63) Continuation-in-part of application No. 09/260,973, filed on Mar. 2, 1999, now Pat. No. 6,231,931.

(51) Int. Cl. B05D 1/36; B05D 3/06; B05D 1/02; B05D 1/28

(52) U.S. Cl. 427/558; 427/397; 427/409; 427/421; 427/428

(57) ABSTRACT

A method of coating a wooden engineered board stock substrate or surface comprising the steps of depositing a layer of a radiation curable, including UV curable, polymer-forming composition, in an uncured form to at least one surface of a wooden engineered board stock substrate; and curing said polymer with an amount of energy sufficient to polymerize the composition. The method, optionally, comprises the further steps of: scuffing the surface of the cured polymer; depositing a second layer of ultraviolet light curable polymer-forming composition, in an uncured form to the scuffed surface; and curing the second layer. The method also contemplates the further step of scuffing the surface of the cured polymer; and then depositing a top coat thereon.

### CROSS REFERENCE TO RELATED APPLICATION

This application is a continuation-in-part application of co-pending U.S. patent application Ser. No. 09/260,973, entitled METHOD OF COATING A SUBSTRATE WITH A STRUCTURAL POLYMER OVERLAY, the disclosure of which is hereby incorporated by reference.

### BACKGROUND OF THE INVENTION

The present invention relates to a method of coating a wooden substrate. More particularly, the present invention relates to a method of coating a wooden substrate with a radiation energy curable polymer. Even more particularly, the present invention relates to a method of coating a wooden substrate with a radiation polymerizable structural polymer having a substantially 100% solids content which is ultraviolet light curable.

### PRIOR ART

In the above referred to co-pending application there is disclosed therein a polymeric overlay for use with certain engineered woods such as plywood or fiberboard and which is particularly adapted for use with the plywood slats used in roll up truck doors or similar product(s). It is disclosed within the co-pending application that the polymeric overlay eliminates the need for a paper overlay veneer covering, or other covering(s) which is (are) typically applied to such plywood substrates or medium density fiberboard slats or similar substrate(s).

As is disclosed hereinafter it has now been found that the polymeric overlay defined within the co-pending application is applicable to other wooden engineered board stock for not only imparting an effective seal but for enhancing the structural integrity of the board stock.

### SUMMARY OF THE INVENTION

In accordance with the present invention there is provided a method for applying a coating to a wooden engineered board stock which comprises:

(a) applying a first layer of a structural polymer, in an uncured form, to at least one surface of the substrate, the polymer being an ultraviolet light or other radiation curable polymer and

(b) curing the polymer of the first layer with ultraviolet light or other radiation energy.

Additionally, after curing the polymer of the first layer, that layer may be scuffed or otherwise roughened to allow application of subsequent layers of the polymer to the resulting surface of the substrate, which additional layers, may be cured and scuffed in repeated or serial fashion to provide as many layers as desired.

The method of the present invention, while eliminating the need for cellulosic based overlays such as paper or wooden veneer, may be used in conjunction therewith. When the layer of structural polymer is applied and cured over a cellulosic overlay, the overlay is effectively sealed and rendered resistant to the effects of weathering.

The present invention is particularly applicable to wooden engineered board stock. The term “wooden engineered board stock”, as used herein is intended to identify any of those well known and commercially available products which are naturally occurring, man-made or compounds derived from mixtures of both. Thus, they include medium density overlay, medium density fiberboard, high density fiberboard, low density fiberboard, plywood, particle board, wheat board, hybrid boards and oriented stand board.

The present invention enables the coating of such a wooden substrate with a structural polymer overlay having a substantially 100% solids content, in an ultraviolet light or other radiation energy curable formulation, to create a water resistant, weather resistant, pore-bridging, grain filling, surface strengthening member. The coating may be used as a single coat or as a layer suitable for receiving additional layers and/or topcoats without the necessity of adhesion promoters, treatments or primers.

For a more complete understanding of the present invention, reference is made to the following detailed description and accompanying examples.

### DETAILED DESCRIPTION OF THE PREFERRED EMBODIMENT

In a first aspect of the present invention, there is provided a method for applying a coating to a wooden substrate which, generally, comprises the steps of:

(a) applying a first layer of a structural polymer-forming composition, in an uncured form, to at least one surface of the substrate, the polymer being a radiation energy and, preferably, light (UV) curable filler polymer; and

(b) curing the composition of the first layer by exposing the polymer-forming composition to radiation energy, preferably, in the ultraviolet range that is between 180 to 400 nanometers.

Additionally, after curing, the polymer of the first layer may be scuffed to allow application of subsequent layers of the polymer-forming composition to the resulting surface of the coated substrate, which subsequent layers may be cured and scuffed, in repeated fashion, to provide as many layers as desired.

The method of the present invention can eliminate the need for paper or similar cellulosic overlays normally applied on exterior paint grade plywood and similar substrates. In addition to potentially eliminating the need for these overlays, such polymer coating provides protection to the underlying substrate from moisture and extreme weather conditions, and, thus, seals the substrate. The provided protection more adequately resists undesired warping and degradation of the substrate than without it. It should be noted, though, that the polymer coating hereof can be utilized in conjunction with the cellulosic overlay to effectively seal the pores of the overlay, protect the underlying wooden substrate from weathering, cleaning methods, chemicals and wear. Furthermore, the polymer coating enhances the structural integrity of the board stock with or without the cellulosic overlay.

According to the method hereof, the first layer of the polymer-forming composition, in an uncured form, is applied, at ambient temperature and pressure, to at least one surface of the substrate to a wet film thickness of about 0.2 to 60 mils and, preferably, to a wet film thickness of about 1.0 to 2.0 mils. The composition is applied to at least one surface of the substrate by any suitable method known to those skilled in the art to which the present invention pertains. Ordinarily, the methods which may be used include, but are not limited to, spraying, immersion or dipping, roll coating (reverse fill, direct roll, etc.), and curtain coating. Alternately, the coating may be applied with a trowel, squeegeed or raked onto the surface.

The reverse fill roll coating method is the method that is preferably used. The reverse fill roll coating method is a method where the uncured polymer-forming composition is applied across the surface of the substrate by direct rolling, either by hand or mechanically, and is followed by a reverse direction rolling, leaving the surface adequately filled with polymer-forming composition.

Once the first layer has been applied onto a surface of the substrate, the first layer is cured by exposure to a radiation energy source, preferably an ultraviolet radiation source within the nanometric range referred to above. As further detailed hereinbelow, the step of curing is a cross-linking reaction which causes the liquid resin(s) to solidify by way of a free radical or cationic polymerization reaction. The mode by which curing the polymer is achieved is dependent on the particular polymer used.

As stated hereinabove, after the application of polymer-forming composition is complete, the polymer is cured. The polymer is cured by exposure to an energy source, preferably a dose or multiple doses of UV radiation, in a dosage which, generally, ranges from between about 0.005 joules/cm² to about 15 joules/cm². Preferably, the radiation dose ranges from between about 1 joules/cm² to about 9 joules/cm². Conversion of the polymer-forming composition from liquid resin(s) to a polymerized solid film or UV curing can be achieved by a single pass or by multiple passes under one or more ultraviolet radiation emitters or irradiators that are commonly referred to as lamps. Using current available technology, curing can be attained using lamps set at or about 300 to 400 watts per inch (wpi) with a conveyor speed set at about 20 to 80 feet per minute (fpm). Typically, curing is achieved within the focal point of one or more focused UV lamps, in order to reduce the likelihood of elevated heat levels. Elevated heat levels may cause the cured polymer to shrink. Elevated heat levels may also cause the cured polymer to crack or damage the substrate. It should be noted that unfocused lamps can be used.

The curing of the UV curable polymer-forming composition is effected by a rapid polymerization reaction that is initiated by a photo-initiator component of the composition, as detailed below, when it is exposed to UV light.

Substantially the entire composition remains in place on the substrate during and after curing.

The first layer is a complete coating in and of itself.

In another embodiment of the invention, after full cure of the first layer of the polymer, the resulting surface of the substrate is scuffed, either manually or mechanically, with an abrasive material, or is sanded using, preferably, a wide belt sander, to remove the uppermost peaks of the cured polymer surface or to smooth out any raised wood grain or to denub the surface. The step of scuffing or sanding promotes adhesion of an additional polymer coating to the substrate or enables the application of a final topcoat, where either of such subsequent coat is desired.

Where a subsequent layer is desired, after the first layer is applied, cured, and scuffed, a second layer of the polymer-forming composition, in an uncured form, may be applied to the resulting surface of the substrate. The second layer may then, also, be cured and scuffed, as detailed hereinabove. Subsequent layers of uncured polymer-forming composition is applied to the coating surface of the substrate, cured, and then scuffed, as necessary, to achieve the desired thickness and effect. Each resulting surface may be sanded or scuffed as detailed hereinbelow to aid in the adhesion upon application of a top coat.

A topcoat may be applied to the coated substrate after the first layer, second layer of the polymer, or any subsequent layer of the polymer-forming composition is applied and cured. Where used, the topcoat is applied at a depth of about 0.1 to 10 mils and, preferably from about 2.0 to 4.0 mils, and cured. The topcoat is, preferably, an ultraviolet radiation curable coating that is cured under a dose of ultraviolet radiation which, preferably, ranges between 1 joules/cm² to 9 joules/cm². The topcoat may be rubbed out, if necessary, to provide the desired effect. The topcoat provides a polymeric material that is multifunctional, enhancing the durability and weatherability of the surface of the substrate, aids in light refraction to make the surface of the substrate aesthetically pleasing, as well as other benefits.

The polymer-forming composition used herein, generally, comprises a polymerizable liquid radiation energy curable polymer-forming composition and a photo-initiator. This composition will allow a free radical or cationic mechanism to occur upon exposure thereof to sufficient ultraviolet radiation. Radiation curable polymer-forming compounds and compositions have an advantage of curing very quickly upon exposure to an ultraviolet radiation source. Upon cure and subsequent prolonged exposure to natural sunlight or artificially produced sunlight and other weathering conditions, the properly formulated ultraviolet cured coating can retain both color and gloss for many years of protection and service.

It is to be appreciated that the first layer of the polymer and subsequent layers thereof according to the method of the present invention may be the same or different polymers.

Preferably, the polymer-forming compound or composition used in the method of the present invention is an acrylate-containing radiation energy curable polymer. Thus, the radiation curable polymer-forming composition may include at least one acrylate-containing compound and the photo-initiator. The acrylate polymer may be selected from the group consisting of monoacrylates, diacrylates, triacrylates, and higher polyacrylates, urethane-modified acrylates, epoxy-modified acrylates, polyester-modified acrylates and mixtures thereof. The polymer, preferably, comprises a mixture of acrylates. Suitable acrylate-containing compounds which may be used in the practice of the present invention include, for example, trimethylolpropane triacrylate, 1,6-hexane diol diacrylate, aliphatic urethane acrylates, vinyl acrylates, epoxy acrylates, ethoxylated bisphenol A diacrylates, polyester diacrylates, and mixtures of the above compositions.

The acrylate or acrylates may be used alone or in admixture with other polymerizable compounds. Representative of such other compounds include, for example, an unsaturated polyester resin, such as, trifunctional acrylic ester, unsaturated cyclic dione, and the like, as well as mixtures thereof. Where an admixture is used, it will, generally, comprise from about 1% to about 70%, by weight, of the adjuvant and 30% to 99% of the acrylate depending on the desired properties of the coating.

The ultraviolet light curable polymer-forming composition is, as noted, generally, admixed with a photoinitiator. Such admixture, usually, comprises from about 80 to about 99.9 percent, by weight, based on the total composition weight, of the polymer; and from about 0.1 to about 20 percent, by weight, based on the total composition weight, of the photoinitiator. Preferably, the composition hereof includes from about 90 to 99.5 percent of the polymerizable compound and from about 0.5 to about 10 percent of the photoinitiator. The photo-initiator initiates a polymerization reaction when the composition is exposed to ultraviolet light. The photoinitiator which is used in the composition of the present invention may be of the free radical or cationic type. A combination of photo-initiators may be used. Photoinitiators which are suitable for use in the practice of the present invention include, but are not limited to, 1-phenyl-2-hydroxy-2-methyl-1propanone, oligo {2 hydroxy-2methyl-1-[4˜(methylvinyl)phenyl]propanone}, 2 hydroxy 2-methyl 1-phenyl propan-1-one, 1-hydroxycyclohexyl phenyl ketone and benzophenone.

Where the application of the polymer onto the substrate involves spraying, generally, a mixture of at least one high molecular weight polymer and at least one low molecular weight polymer is used. Thus, at ambient temperature and pressure, a preferred mixture of 40% high molecular weight polymers and 60% low molecular weight polymers allows for an effective spraying application to form the polymer layers.

The present invention contemplates polymerization other than with a UV-activated photoinitiator package. Thus, electron beam exposure will initiate cross-linking without the exposure to UV light as detailed below. Chemical reaction initiator may, also, be used herein, depending on the polymer-forming composition.

Where UV light is used, any suitable source thereof may be used. Thus, the polymer-forming composition of the present invention may be cured by natural sunlight, artificial UV lights, or long wave ultraviolet light depending on the photoinitiator package used. The cure by artificial UV lights may include medium pressure mercury vapor lamps, doped lamps, electrodeless lamps, pulse xenon lamps, hybrid lamps, low pressure germicidal lamps, and the like.

To provide a superior surface, each application of the polymer-forming composition after the first layer is raked into the valleys in the resulting surface with, preferably, a flat straight edge or is allowed to self-level into the valleys of the cured polymer surface.

As applied, the first layer of the polymer settles upon the surface of the substrate, the first layer occupying the pores thereof. The first layer, thus, provides a filler medium that creates a seal to prevent outside moisture from changing the integrity of the substrate. The second and subsequent layers provide added protection as well as added thickness of the overlay as desired by the end user.

Any post-first layers of the polymer are applied, when necessary, in an uncured form to the surface of the substrate at a depth of about 0.2 to 60 mils and, preferably, from about 1.0 to 2.0 mils, and cured until the valleys of the surface are filled, the surface of the substrate is smooth, and the desired thickness and effect is achieved. As further detailed hereinbelow, once each application of the polymer is cured, the peaks of the surface may be flattened, such as by scuffing or sanding, until the surface of the substrate is level. The inside of any low spots or recesses may be manually finished to aid the adhesion of the next application of the polymer.

Although described hereinabove as preferably a wooden substrate, the substrate to which the present coating is applied may be any material that allows proper adhesion and curing of the polymer in accordance with the method of the present invention. The substrate may be, but is not limited to, an exterior grade veneer plywood such as Poplar face/Fircore plywood with exterior glue.

Also, as noted hereinabove, a topcoat may be applied as the final step. Preferably, the topcoat is an ultraviolet light curable coating composition and most preferably is an acrylate system of one or more acrylates. Such acrylates include, but are not limited to, aliphatic urethane acrylate, epoxy acrylate, monofunctional acrylate monomer, and aliphatic trifunctional acrylate.

The resulting surface or coating protects the substrate from weathering effects and lessens the potential of degradation and warping thereof. The resulting surface may be used as an outside surface or paneling of equipment or apparatus that is exposed to outdoor weather such as any exterior grade wooden natural or engineered board stock. It is particularly useful as a roll-up panel door mounted on panel or delivery trucks, semi-truck trailers, railcars, and the like.

As noted hereinabove, the present invention is particularly applicable to any of the well-known “wooden engineered board stock” including, for example, medium density overlay, medium density fiberboard, high density fiberboard, light density fiberboard, oriented strand board, plywood, particle board, wheat board, hybrid board, and the like. The substrate may, optionally, have secured or otherwise affixed thereto a veneer which may comprise a mixture of wooden and naturally curing material that may further be refined and/or processed with a polymeric, natural occurring, synthetic or man-made material, or a mixtures thereof.

As is known to those skilled in the art to which the present invention pertains engineered board stock may comprise naturally occurring, man made or a mixture of both types of compounds. Representative of the naturally occurring materials used in a board stock include, for example, finely chopped wheat straw and stakes, cellulosic fibers, agriculturally produced and separated material such as grain, nut, bean stakes, bean shafts, corn husk, shells that are processed as fillers and which may subsequently be mixed with other recycled or virgin materials such as shredded newspaper, telephone books, inorganic or organic fillers or pigments, such as silicas, calcium carbonates, talcs, iron oxides, titanium dioxides; solid, powdered, or shredded plastics and be impregnated with a fluidized thermoplastic or thermoset polymer resin. These are further processed into the board stock products.

Representative of the synthetic materials may be virgin and/or recycled plastics such as, for example low density polyethylene, high density polyethylene, PET, polyvinyl chloride, polyurea, polypropylene, polyurethane, polycarbonates, polyesters and the like as well as mixtures thereof. Furthermore, natural and synthetic rubbers filled or unfilled may also be used. Similarly, the board stock may be solid, or foam as well as being reinforced or fortified. All such are contemplated as being within the scope of the definition of “wooden engineered board stock” as used herein and in the appended claims.

As in the first aspect of the present invention, the layer of a structural polymer-forming composition, in an uncured form is applied to at least one surface of a substrate, at ambient temperature and pressure, to a wet film thickness of about 0.2 to 60 mils and, preferably, to a wet film thickness from about 3 to 8 mils.

In practicing the present invention, additives may be added to the curable, filler polymer composition and the curable topcoat. Such additives include, but are not limited to, pigments, flow additives, sanding agents, inert fillers, reinforcement fibers, and other suitable matter.

It is readily understood that the present invention defines a substantially 100% solids radiation curable composition. Such a 100% solids content UV-curable polymer is more particularly described in U.S. Letters Patent No. 5,453,451, the disclosure of which is hereby incorporated by reference.

For a more complete understanding of the present invention reference is made to the following illustrative examples. In the examples all parts are by weight absent indications to the contrary.

### EXAMPLE I

At ambient temperature and pressure, a first layer of a UV curable filler polymer-forming composition is applied to a surface of an exterior grade veneer plywood to a wet film thickness of 1.5 mils, by reverse fill roll-coating. The surface with the uncured filler composition is, then, cured by exposure to a UV light source at 2 joules/cm². The first layer of cured UV curable filler polymer is scuffed or sanded with 180 grit sandpaper. Next, a second layer, deposited to a depth of 1.5 mils, of uncured ultraviolet curable polymer-forming composition is applied to the scuffed surface. The second layer is cured by exposure to a UV light source at 2 joules/cm². The second layer of cured UV curable filler polymer is scuffed with 180 grit sandpaper. Then 2 mils of topcoat is applied and UV cured at 2 joules/cm².

The UV curable filler polymer-composition used herein is:

| Component | Amount, pbw |
|---|---|
| aliphatic urethane acrylate | 30.0 |
| monofunctional acrylate monomer | 30.0 |
| difunctional acrylate monomer | 15.0 |
| aliphatic trifunctional acrylate | 10.0 |
| photo-initiator | 4.0 |
| additives | 11.0 |
| TOTAL | 100.0 |

The UV curable topcoat has the following composition

| Component | Amount, pbw |
|---|---|
| aliphatic urethane acrylate | 20.0 |
| epoxy acrylate | 10.0 |
| monofunctional acrylate monomer | 20.0 |
| difunctional acrylate monomer | 20.0 |
| aliphatic trifunctional acrylate | 21.0 |
| photo-initiator | 4.0 |
| additives | 5.0 |
| TOTAL | 100.0 |

The degree of adhesion of the layer on the plywood surface is determined using crosshatch and tape pull-off methods performed on the resulting surface in accordance with ASTM test procedure D 3359/B.

When so-tested, the cured polymer exhibits excellent adhesion to the plywood surface.

### EXAMPLE II

This example illustrates a further radiation curable composition in accordance herewith.

An ultraviolet polymeric filler is prepared from the following ingredients:

| Component | Amount, pbw |
|---|---|
| aliphatic urethane acrylate | 40.0 |
| trifunctional acrylate monomer | 15.0 |
| photo-initiators | 5.5 |
| additives, inerts, pigments, and sanding | 39.5 |
| agents | |
| TOTAL | 100.0 |

### EXAMPLE III

This example illustrates a ultraviolet light curable primer formulation in accordance with the present invention:

| Component | Amount, pbw |
|---|---|
| aromatic monoacrylate | 28.00 |
| photoinitiator | 5.00 |
| trifunctional acrylate monomer | 29.00 |
| monofunctional acrylate monomer | 21.00 |
| pigments, inerts, sanding agents | 16.75 |
| additives | .25 |
| TOTAL | 100.00 |

### EXAMPLE IV

This example illustrates an ultraviolet light curable top coating composition for use in the practice of the present invention.

| Component | Amount, pbw |
|---|---|
| aliphatic urethane acrylate | 24.00 |
| acrylate amine oligomer | 5.00 |
| difunctional acrylate monomer | 10.25 |
| monofunctional acrylate monomer | 18.00 |
| photo-initiators | 5.75 |
| pigments, inerts, sanding and flatting agents | 28.00 |
| additives | 4.00 |
| vinyl ether or difunctional monomer | 5.00 |
| TOTAL | 100.00 |

It has been observed that the instant radiation energy curable filler polymer hereof may be used in conjunction with other coatings, such as paints, and the like. Similarly, the filler polymer hereof may be applied over a previously coated board stock substrate.

The method of the present invention renders itself susceptible to many variants. For example, there may be a wet-on-wet application of the first and second layers of polymeric coating composition where there is no need to scuff or sand to promote adhesion. The second layer and any subsequent layers may be scuffed or sanded after cure.

Similarly, there may be only partial or gel-curing of the first layer followed by the deposit of the next layer and then, full cure, of both layers together. Again, there is no need for scuffing or sanding to obtain adhesion between the first and second layers. After the second layer is fully cured, there may be scuffing or sanding thereof for the application of a subsequent layer or a top coat.

Also, after cure, there may be no need for scuffing or sanding between layers. Thus, there may be no scuffing or sanding between the first and second layers while the second layer is scuffed for subsequent application of a third layer. As another variant, there may be no scuffing or sanding between the second or third layers rendering it self-priming and recoatable and, then, after cure, the third layer is scuffed for application of subsequent layers.

Furthermore, and as noted hereinabove, the present invention is not limited to UV light cure of the polymer-forming composition but electron beam as well as free radical or cationic cross-linking may be used to form the polymer.

Additionally, the top coat may not necessarily be defined or comprise an acrylate-functional compound but may comprise another type of “top coat” such as a laminated film or a metal or plastic layer being adhered to the coated substrate, such as a metal clad plastic, a dichroic layer, or the like may be applied as the top coat.

Having thus described the invention, what is claimed is:

1. A method of coating a wooden substrate, the method comprising the steps of:
(a) depositing a layer of ultraviolet light curable polymer-forming composition, in an uncured form, to at least one surface of a wooden substrate; and
(b) curing said polymer with an amount of UV energy sufficient to polymerize said polymer.

2. A method of coating an engineered wooden board stock, the method comprising the steps of:
(a) depositing a layer of a radiation curable polymer-forming composition, in an uncured form, to at least one surface of the engineered wooden board stock substrate; and
(b) curing said polymer-forming composition with an amount of radiation energy sufficient to polymerize said polymer.

3. The method of claim 2 further comprising the steps of:
(a) scuffing the surface of the cured polymer;
(b) depositing a second layer of a radiation curable polymer-forming composition, in an uncured form, to the scuffed surface; and
(c) curing the second layer of radiation curable polymer-forming composition with an amount of energy sufficient to polymerize said second layer.

4. The method of claim 2 further comprising the steps of
(a) scuffing the surface of the cured polymer; and
(b) depositing a top coat thereon.

5. The method of claim 2 wherein the radiation curable polymer-forming composition comprises a substantially 100% solids composition.

6. The method of claim 2 wherein the radiation curable polymer comprises:
at least one acrylate functional polymer.

7. The method of claim 6 wherein the at least one acrylate functional polymer is selected from the group consisting of monoacrylates, diacrylates, triacrylates, higher polyacrylates, urethane-modified acrylates, epoxy acrylates, polyester-modified acrylates and mixtures thereof.

8. The method of claim 6 wherein the radiation curable polymer-forming composition is an admixture with a photoinitiator.

9. The method of claim 8 wherein the photoinitiator is present in an amount from about 0.1% to about 20% by weight based on the total composition weight.

10. The method of claim 2 wherein the step of depositing comprises:
roll coating the polymer-forming composition onto the substrate.

11. The method of claim 2 wherein the step of depositing comprises:
spraying the composition onto the surface of the substrate, the polymer comprising a mixture of at least one high molecular weight compound and at least one low molecular weight compound present in an amount sufficient to allow effective spraying of the polymer.

12. A method of coating and strengthening an engineered wooden board stock wooden substrate, the method comprising the steps of:
(a) depositing a first layer of fiberglass material onto the substrate;
(b) depositing a layer of an ultraviolet light curable polymer-forming composition, in an uncured form, onto the layer of fiberglass material; and
(c) curing said composition with an amount of UV energy sufficient to polymerize said composition.

13. The method of claim 12 wherein:
the board stock has a cellulosic overlay, the first layer being deposited over the overlay.

14. The method of claim 3 wherein:
the polymer-forming composition of the first layer and the polymer-forming composition of the second layer are different.

15. The method of claim 13 wherein: the polymer-forming composition of the first layer and the polymer-forming composition of the second layer are the same.

16. The method of claim 14 wherein the polymer-forming compositions are each UV curable acrylate functional compositions.

17. The method of claim 15 wherein: the polymer-forming compositions are each UV curable acrylate functional compositions.

18. The method of claim 17 wherein the curing is effected by free radical polymerization.

19. The method of claim 17 wherein curing effected by a cationic reaction.
